(19) United States
(12) Patent Application Publication
(10) Pub. No.: US 2014/0174707 A1
(43) Pub. Date: Jun. 26, 2014

(54) METHOD AND SYSTEM FOR THERMAL STORAGE IN A VEHICLE

(71) Applicant: GM GLOBAL TECHNOLOGY OPERATIONS LLC, Detroit, MI (US)

(72) Inventors: Paul S. Lombardo, Commerce Township, MI (US); Lawrence P. Ziehr, Clarkston, MI (US); Matthew Simonini, Greenville, SC (US)

(73) Assignee: GM GLOBAL TECHNOLOGY OPERATIONS LLC, Detroit, MI (US)

(21) Appl. No.: 13/724,328

(22) Filed: Dec. 21, 2012

(51) Int. Cl. B60H 1/00

(52) U.S. Cl. CPC B60H 1/004
USPC 165/202

(57) ABSTRACT

A method for charging a thermal storage device of a thermal storage heat pump system in a vehicle is provided. The method includes comparing an actual temperature of the thermal storage device to a target temperature, and an actual charge time to an available charge time, where the comparing is performed by a controller. The target temperature may be based upon ambient air temperature and ambient air humidity. The actual charge time is the time it takes to charge the thermal storage device to the target temperature. The available charge time is the difference between the current time and an intended departure time. When the target temperature is greater than the actual temperature, and the available charge time is equal to or greater than the actual charge time, the controller may charge the thermal storage device until the actual temperature is equal to the target temperature.

### TECHNICAL FIELD

The present invention relates to a method for storing thermal energy in a vehicle, such as a hybrid electric vehicle (HEV) or a plug-in hybrid electric vehicle (PHEV), and a system for implementing the method.

### BACKGROUND

An electric vehicle, such as a hybrid electric vehicle (HEV), a plug-in hybrid electric vehicle (PHEV), or the like, generally includes an electric motor, which may alone propel the vehicle in an electric vehicle (EV), or charge-depleting, drive mode. The vehicle may also include an internal combustion engine (ICE) to serve as the primary propulsion system of the vehicle in a range extending mode, or to operate in conjunction with the electric motor in a hybrid, or charge-sustaining, mode.

The electric motor generally receives electric power from an electric power source, such as an energy storage system (ESS). The ESS may include a battery pack or other rechargeable energy storage means capable of storing large amounts of thermal energy. The ESS may store the thermal energy when the vehicle is connected to an external power source, such as an electrical grid, for charging. In colder ambient temperatures, the charge depletes faster, due to various factors.

The ESS may be used in conjunction with a thermal management system, such as a heat pump system, to transfer the stored thermal energy to another medium for another purpose, such as to heat a passenger compartment of the vehicle.

### SUMMARY

A method for charging a thermal storage device of a thermal storage heat pump system in a vehicle is provided. The vehicle generally has an inactive charging state in which the vehicle is turned off and may be connected to an external power source for charging, and an active drive state. The method is applied when the vehicle is switched to the inactive charging state from the active drive state.

The method includes first measuring an actual temperature of the thermal storage device. The method then includes determining a target temperature for the thermal storage device. This may be performed by a controller within the thermal storage heat pump system. The controller may analyze certain parameters, including, but not limited to, ambient air temperature and ambient air humidity, to determine the optimal target temperature. The ambient air temperature and humidity may be measured by a temperature sensor and a humidity sensor, respectively. The temperature sensor and the humidity sensor are configured to take their respective measurements, and to transmit those measurements to the controller.

The method further includes determining an actual charge time needed to heat the thermal storage device to the target temperature. The controller may determine the actual charge time based upon certain factors such as the electrical power source and the type of thermal storage device. The method then includes determining an available charge time. The controller determines the available charge time by calculating the difference between a current time and a departure time. The current time is the time at which the vehicle enters the inactive charging state. The departure time is the time at which the vehicle is intended to reenter the active drive state. The departure time may be transmitted to the processor via an input module.

The method further includes comparing the actual temperature of the thermal storage device to the target temperature, and the actual charge time to the available charge time. If the target temperature is greater than the actual temperature, and the available charge time is equal to or greater than the actual charge time, then the controller may initiate charging.

A thermal storage heat pump system of a vehicle implementing the above method is also provided. Again, the vehicle generally has an inactive charging state and an active drive state. The thermal storage heat pump system generally includes a coolant circuit, a thermal storage device located in the coolant circuit, and a controller. The coolant circuit is configured to circulate a coolant, particularly through the thermal storage device to remove heat from it. The thermal storage device is configured to store thermal energy as it is being charged when the vehicle is in the inactive charging state. The controller is configured to determine whether to charge the thermal storage device when the vehicle is in the inactive charging state based on the method described above. The controller is further configured to initiate and terminate charging based on its determination of whether to charge the thermal storage device.

The thermal storage heat pump system may also include a temperature sensor, a humidity sensor, and an input module. The temperature sensor may be configured to measure the ambient air temperature, and to transmit the measurement to the controller. Similarly, the humidity sensor may be configured to measure the ambient air humidity, and transmit the measurement to the controller. The input module may be configured to transmit the departure time to the controller.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic diagram of a thermal storage heat pump system having a thermal storage device;

FIG. 2 is a schematic flow diagram of a method for thermal storage in the thermal storage device during charging;

FIG. 3 is a schematic flow diagram illustrating one step of the method of FIG. 2;

FIG. 4 is a schematic flow diagram illustrating another step of the method of FIG. 2; and

FIGS. 5 and 6 are graphs illustrating the determination of a target temperature of the thermal storage device in the method of FIGS. 2-4.

### DETAILED DESCRIPTION

The following description and figures refer to example embodiments and are merely illustrative in nature and not intended to limit the invention, its application, or uses. Throughout the figures, some components are illustrated with standardized or basic symbols. These symbols are representative and illustrative only, and are in no way limiting to any specific configuration shown, to combinations between the different configurations shown, or to the claims. All descriptions of componentry are open-ended and any examples of components are non-exhaustive.

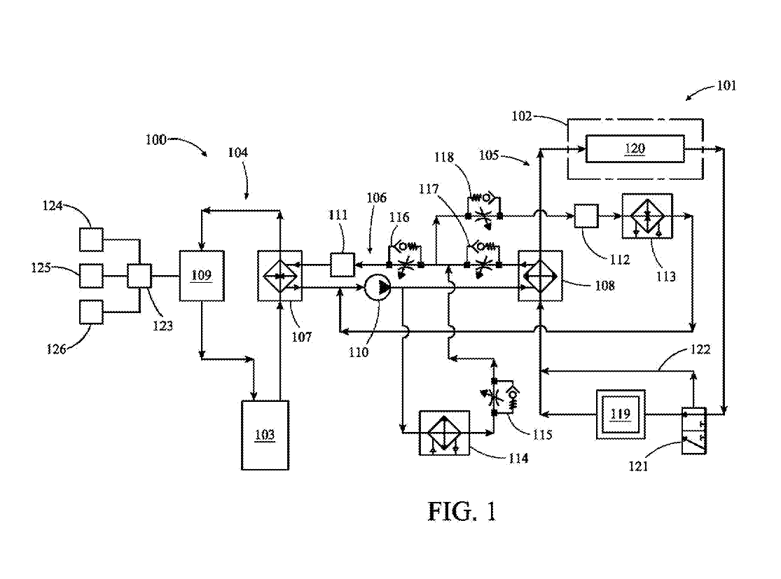

Referring to the drawings, wherein like reference numbers correspond to like or similar components wherever possible throughout the several figures, a thermal storage heat pump system 100 for use in a vehicle 101, including, but not limited to, a hybrid electric vehicle (HEV), a plug-in hybrid electric vehicle (PHEV), or the like, is shown in FIG. 1. The vehicle 101 may selectively operate in a range extending mode, a hybrid, or charge-sustaining, mode, and an electric vehicle (EV), or charge-depleting, drive mode. In range extending mode, an internal combustion engine (ICE) 119, described hereinafter, operates as the sole propulsion system for the vehicle 101. In hybrid mode, the vehicle 101 operates using both electric power from an electric motor (not shown) and power from the ICE 119. In EV drive mode, the vehicle 101 operates solely on electricity.

The thermal storage heat pump system 100 generally includes a thermal storage device 103 and a first coolant circuit 104 in which the thermal storage device 103 is located. The thermal storage device 103 may be any medium, device, machine, or the like, capable of generating and storing thermal energy. For example, the thermal storage device 103 may be an energy storage system (ESS) that includes at least one battery or battery pack.

The first coolant circuit 104 is configured to circulate a first coolant, particularly through or in heat exchange relationship with the thermal storage device 103 to remove heat from it. The heat may be transferred to a passenger compartment 102 of the vehicle 101 to heat the passenger compartment 102, as described in more detail below.

The thermal storage heat pump system 100 further may include a second coolant circuit 105 and a refrigeration circuit 106. The second coolant circuit 105 and the refrigeration circuit 106 may be configured to circulate a second coolant and a refrigerant, respectively.

The refrigeration circuit 106 may be in thermal communication with the first coolant circuit 104 and the second coolant circuit 105 via a first heat exchanger 107 and a second heat exchanger 108, respectively. The first heat exchanger 107 may be a refrigerant-to-liquid chiller heat exchanger that may function as a heat pump evaporator to dissipate heat from the first coolant in the first coolant circuit 104 to the refrigerant in the refrigeration circuit 106. The second heat exchanger 108 may also be a refrigerant-to-liquid heat exchanger that may function as a heat pump condenser to dissipate heat from the refrigerant in the refrigeration circuit 106 to the second coolant in the second coolant circuit 105.

The first coolant circuit 104 may include a heater 109. The heater 109 may be configured to heat the first coolant in the first coolant 104, which flows to the thermal storage device 103 where the heat may be deposited and stored. The heater 109 may be, but is not limited to, a resistive heater.

The refrigerant circuit 106 may include a compressor 110 located downstream of the first heat exchanger 107 and upstream of the second heat exchanger 108. The compressor 110 may be configured to compress the refrigerant.

The refrigerant circuit 106 may further include a first thermal expansion device 111, a second thermal expansion device 112, a third heat exchanger 113, and a fourth heat exchanger 114. The first thermal expansion device 111 and the second thermal expansion device 112 may be located downstream of the second heat exchanger 108, and may be configured to cool and expand the refrigerant to be distributed to the first heat exchanger 107 and the third heat exchanger 113, respectively. The first thermal expansion device 111 and the second thermal expansion device 112 may be thermostatic or thermal expansion valves, and may be either electronically or mechanically actuated.

The third heat exchanger 113 may be an ambient-to-refrigerant heat exchanger that may function as a cabin evaporator. It may be configured to exchange heat from the refrigerant flowing through it to air flowing across it and into the passenger compartment 102 to cool and dehumidify the passenger compartment 102. The fourth heat exchanger 114 may be a refrigerant-to-ambient heat exchanger, and may function as a condenser for an air conditioning (A/C) system (not shown) of the vehicle 101.

The refrigeration circuit 106 may further include a plurality of flow control valves 115, 116, 117, and 118. The flow control valves 115, 116, 117, and 118 may be configured to control the flow to the various components in the refrigeration circuit 106. It should be appreciated that the flow control valves 115, 116, 117, and 118 may be any valve capable of restricting the flow of refrigerant in a particular line. The flow control valves 115, 116, 117, and 118 may be, but are not limited to, two-position, open/closed valves, or alternatively, modulating valves.

The second coolant circuit 105 may include the ICE 119, mentioned above, and a heater core 120. The ICE 119 may have heat within it from having been in operation. The heat may be deposited in the second coolant, thereby cooling the ICE 119. The coolant heater core 120 may be configured to receive the second coolant to heat air that was dehumidified by the third heat exchanger 113, thereby effectively transferring heat stored in the thermal storage device 103 to the passenger compartment 102.

The second coolant circuit 105 further may include a bypass valve 121 and a bypass line 122. The bypass valve 121 is configured to selectively direct the second coolant to the ICE 119 to cool it when the vehicle 101 is in hybrid mode, or to the bypass line 122 when the vehicle 101 is in EV drive mode. While the bypass valve 121 is shown in FIG. 1 as a two-position three-way valve, it should be appreciated that the bypass valve 121 may be any three-way valve configured to selectively direct the flow to the ICE 119 and/or to the bypass line 122. In an alternative embodiment not shown, in lieu of a three-way valve, there may be two separate flow control valves, one each on the bypass line 122 and the second coolant circuit 105 downstream of the takeoff for the bypass line 122.

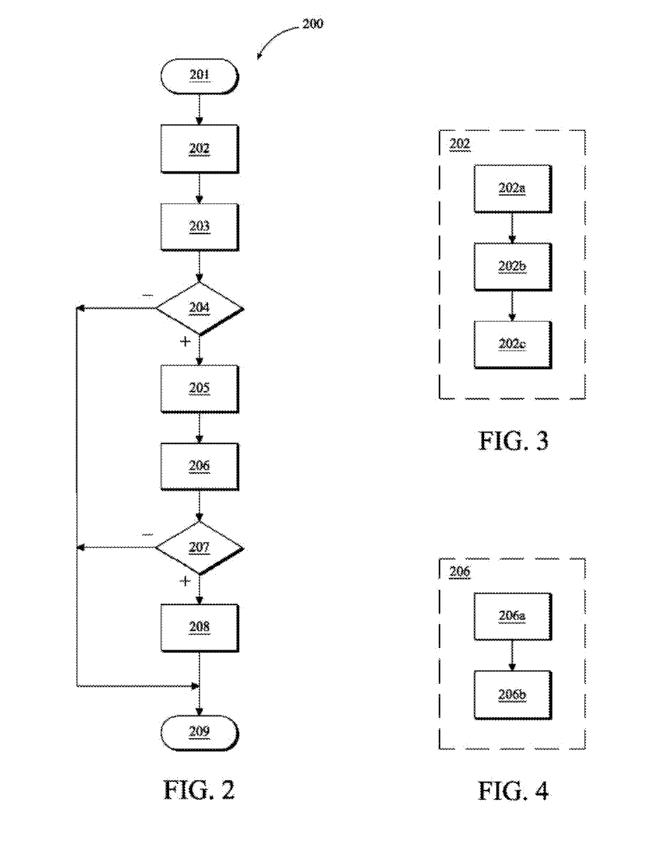

The thermal storage heat pump system 100 may also include at least one controller 123 to control the operation of the thermal storage heat pump system 100. In particular, the controller 123 may control the charging and heating of the thermal storage device 103 based on certain parameters, including, but not limited to, humidity, ambient air temperature, time of day, the intended departure time at which the vehicle 101 is to reenter the active drive state from the inactive charging state, and the like, as depicted in FIGS. 2-6 and described in more detail hereinafter.

The controller 123 may be electrically connected to the thermal storage heat pump system 100 via at least one electrical connection. The controller 123 may be configured to communicate with the heater 109 to control the amount of thermal energy to be stored in the thermal storage device 103, i.e., the target temperature for the thermal storage device 103. The controller 123 also may be configured to communicate with and receive information from ancillary devices, including, but not limited to, a temperature sensor 124, a humidity sensor 125, and an input module 126. The controller 123 may process the information received from these devices to determine the target temperature for the thermal storage device 103, and control the heater 109 and other devices accordingly. The controller 123 may further be configured to control the compressor 110, the first and second thermal expansion devices, 111 and 112, the flow control valves 115, 116, 117, and 118, any other devices in the thermal storage heat pump system 100, and any other subsystems in the vehicle 101.

The temperature sensor 124 generally is any device configured to measure the ambient air temperature. Similarly, the humidity sensor 125 is any device configured to measure the humidity of the ambient air. The input module 126 may be any device configured to receive an input or other data from a user of the thermal storage heat pump system 100. For example, the input module 126 may be, but is not limited to, a mobile phone, an onboard computer in the vehicle 101, and the like.

The temperature sensor 124, the humidity sensor 125, and the input module 126 further may be configured to transmit data, such as the ambient air temperature measurement, humidity measurement, and departure time of the vehicle 101, to the controller 123 to be stored and/or processed. The temperature sensor 124, the humidity sensor 125, and the input module 126 may be external to the controller 123, and may transmit the data through a wired or wireless connection. In another embodiment, the temperature sensor 124, the humidity sensor 125, and the input module 126 may be internal to the controller 123. In yet another embodiment, the controller 123 may be configured to obtain such data as the ambient air temperature, humidity, and the time of day from a remote source (not shown) via the internet or other communications network.

Referring to FIG. 2, a method 200 for controlling the thermal storage heat pump system 100, particularly for storing thermal energy in the thermal storage device 103, is shown. Method 200 begins at step 201, in which the vehicle 101 is in an inactive charging state, and is connected to an external power source, such as an electrical grid, for charging the thermal storage device 103. After step 201, method 200 proceeds to step 202.

At step 202, a desired target temperature for the thermal storage device 103 is determined. Step 202 may be performed by the controller 123, and may include sub-steps 202a-c, as depicted in FIG. 3.

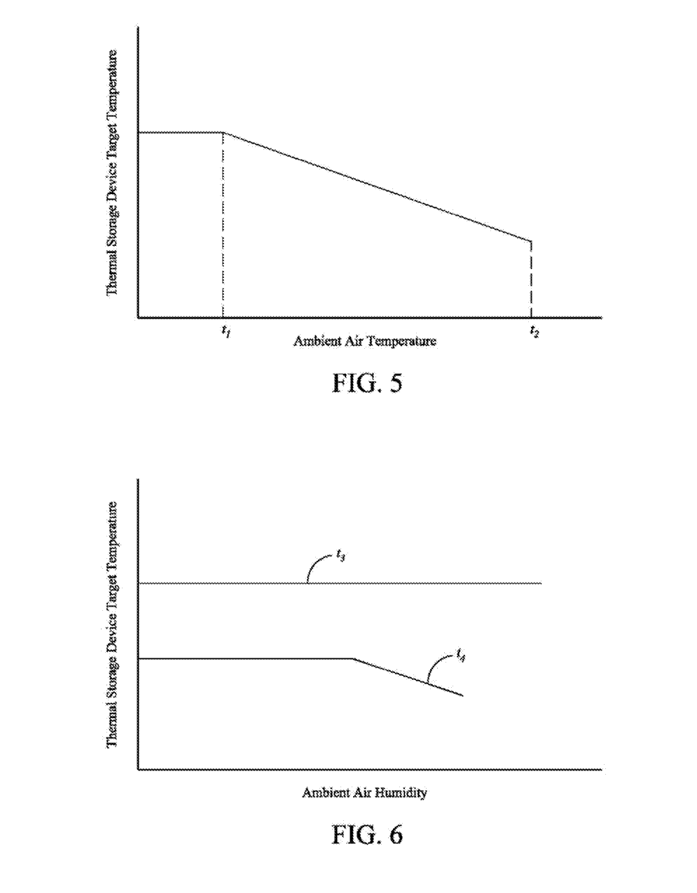

Referring to FIG. 3, at step 202a, ambient air temperature is measured, which may be performed by the temperature sensor 124. The temperature sensor 124 may then transmit the ambient air temperature measurement to the controller 123. At step 202b, the ambient air humidity is measured by the humidity sensor 125. The humidity sensor 125 may then transmit the humidity measurement to the controller 123. At step 202c, the controller 123 processes the ambient air temperature and the humidity measurements to determine the desired target temperature for the thermal storage device 103. The target temperature may be related to the humidity and to the ambient air temperature as depicted in the graphs of FIGS. 5 and 6, respectively.

Referring to FIG. 5, below a first ambient air temperature, designated as t₁, the target temperature may remain the same. For example, the target temperature may remain constant where the ambient air temperature is −20 degrees C. and below. However, as the ambient air temperature increases above t₁, the desired target temperature may decrease. When the ambient air temperature reaches a second temperature, designated as t₂, the thermal storage device 103 may not need to be charged.

Referring to FIG. 6, the target temperature is not significantly affected by humidity at lower ambient air temperatures, as depicted by the exemplary curve of the target temperature at a lower ambient air temperature, designated as t₃. However, at a higher ambient air temperature, the target temperature may begin to decrease with increasing humidity, as depicted by the exemplary curve of the target temperature at the higher ambient air temperature, designated as t₄. For example, where the ambient air temperature is 10 degrees C., the target temperature may begin decreasing at 50% humidity. Furthermore, at a certain temperature and humidity, the thermal storage device 103 may not need to be charged.

These relationships between the target temperature and the ambient air temperature and/or humidity may be programmed into the controller 123. Therefore, when the controller 123 receives measurements of the ambient air temperature and the humidity from the temperature sensor 124 and the humidity sensor 125, respectively, the controller 123 may determine the appropriate target temperature for the thermal storage device 103. These relationships may be adjustable.

Referring back to FIG. 2, method 200 proceeds to step 203 after step 202. At step 203, the actual temperature of the thermal storage device 103 is measured. The thermal storage device 103 may have a temperature sensor (not shown) configured to read the temperature of the thermal storage device 103 and transmit it to the controller 123.

After step 203, method 200 proceeds to step 204. At step 204, the controller 123 determines whether the actual temperature of the thermal storage device 103 is less than the target temperature. If it is, method 200 proceeds to step 205. Otherwise, method 200 proceeds to step 209 at which method 200 ends.

At step 205, the controller 123 determines the actual charge time necessary to heat up the thermal storage device 103 to the target temperature determined at step 202. This may be dependent upon certain factors, including, but not limited to, the external power source to which the vehicle 101 is connected for charging, e.g., whether it is 110 V or 220 V, and the type of thermal storage device 103, e.g., its thermal energy storage characteristics.

After step 205, method 200 proceeds to step 206. At step 206, the controller 123 determines the available charge time, which is the length of time available before the vehicle 101 is intended to enter the active drive state from the inactive charging state, or the departure time. This may include several sub-steps 206a-b, as depicted in FIG. 4.

Referring to FIG. 4, at step 206a, the input module 126 receives the intended departure time of the vehicle 101 as entered by a user of the thermal storage heat pump system 100. The input module 126 may then transmit the departure time to the controller 123. At step 206b, the controller 123 determines the available charge time by subtracting the departure time from the current time. The current time may be pre-programmed into the controller 123, or may be entered by the user via the input module 126. Alternatively, as explained above, the controller 123 may be configured to retrieve the current time from a remote source (not shown) via the internet or other communications network.

Referring back to FIG. 2, method 200 proceeds to step 207 after step 206. At step 207, the controller 123 determines whether the available charge time is equal to or greater than the actual charge time. If it is, then method 200 proceeds to step 208. Otherwise, method 200 proceeds to step 209 at which method 200 ends.

At step 208, the controller 123 initiates charging of the thermal storage device 103 until the actual temperature of the thermal storage device 103 is equal to the target temperature. At this point, method 200 proceeds to step 209 at which method 200 ends.

Generally, losses may be incurred during the storing of thermal energy in the thermal storage medium 103 due to overcharging of the thermal storage medium 103 or thermally charging at a time that in which it is unnecessary to do so. The thermal storage heat pump system 100 and method 200 allow for optimal thermal charging of the thermal storage device 103, which may be particularly useful at lower ambient air temperatures when the charge of the thermal storage medium depletes at a faster rate.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method for charging a thermal storage device of a thermal storage heat pump system in a vehicle having an inactive charging state and an active drive state, the method comprising:
measuring an actual temperature of the thermal storage device;
determining, by a controller, a target temperature for the thermal storage device;
determining, by the controller, an actual charge time to heat the thermal storage device to the target temperature;
determining, by the controller, an available charge time to heat the thermal storage device to the target temperature; and
comparing, by the controller, the actual temperature to the target temperature, and the actual charge time to the available charge time;
wherein the thermal storage device is configured to store thermal energy as it is being charged when the vehicle is in the inactive charging state.

2. The method of claim 1 wherein the thermal storage device is an energy storage system (ESS) having at least one battery pack.

3. The method of claim 1 further comprising charging the thermal storage device when the target temperature is greater than the actual temperature, and when the available charge time is equal to or greater than the actual charge time, until the actual temperature is equal to the target temperature.

4. The method of claim 1 wherein the determining of the target temperature comprises measuring ambient air temperature to obtain an ambient air temperature measurement.

5. The method of claim 4 wherein the determining of the target temperature further comprises transmitting the ambient air temperature measurement to the controller.

6. The method of claim 5 wherein the measuring of the ambient air temperature and the transmitting of the ambient air temperature measurement to the controller is performed by a temperature sensor.

7. The method of claim 5 wherein the determining of the target temperature further comprises measuring ambient air humidity to obtain a humidity measurement.

8. The method of claim 7 wherein the determining of the target temperature further comprises transmitting the humidity measurement to the controller.

9. The method of claim 8 wherein the measuring of the ambient air humidity and the transmitting of the humidity measurement to the controller is performed by a humidity sensor.

10. The method of claim 1 wherein the determining of the available charging time comprises calculating the difference between a current time and a departure time, wherein the current time is when the vehicle enters the inactive charging state, and the departure time is when the vehicle is intended to switch from the inactive charging state to the active drive state.

11. The method of claim 10 wherein the departure time is transmitted to the controller by an input module.

12. A thermal storage heat pump system of a vehicle having an inactive charging state and an active drive state, the system comprising:
a coolant circuit configured to circulate a coolant;
a thermal storage device located in the coolant circuit, the thermal storage device being configured to store thermal energy as it is being charged when the vehicle is in the inactive charging state; and
at least one controller configured to:
determine whether to charge the thermal storage device when the vehicle is in the inactive charging state, based on at least one condition;
initiate charging of the thermal storage device after the controller has determined that the at least one condition has been satisfied; and
terminate charging of the thermal storage device after the controller has determined that the at least one condition is no longer satisfied.

13. The thermal storage heat pump system of claim 12 wherein the thermal storage device is an energy storage system (ESS) having at least one battery pack.

14. The thermal storage heat pump system of claim 12 wherein the at least one condition comprises a target temperature of the thermal storage device being greater than an actual temperature of the thermal storage device.

15. The thermal storage heat pump system of claim 14 wherein the at least one condition further comprises an actual charge time to charge the thermal storage device to the target temperature being greater than an available charge time.

16. The thermal storage heat pump system of claim 14 wherein the at least one controller is further configured to determine the target temperature of the thermal storage device based on ambient air temperature and ambient air humidity.

17. The thermal storage heat pump system of claim 16 further comprising a temperature sensor configured to measure the ambient air temperature to obtain an ambient air temperature measurement, and to transmit the ambient air temperature measurement to the at least one controller.

18. The thermal storage heat pump system of claim 16 further comprising a humidity sensor configured to measure ambient air humidity to obtain a humidity measurement, and to transmit the humidity measurement to the at least one controller.

19. The thermal storage heat pump system of claim 15 wherein the at least one controller is further configured to determine the available charge time by calculating the difference between a current time and a departure time, wherein the current time is when the vehicle enters the inactive charging state, and the departure time is when the vehicle is intended to switch from the inactive charging state to the active drive state.

20. The thermal storage heat pump system of claim 19 further comprising an input module configured to transmit the departure time to the at least one controller.
